(19) United States
(12) Patent Application Publication
(10) Pub. No.: US 2025/0219539 A1
(43) Pub. Date: Jul. 3, 2025

(54) CONTROL CIRCUIT AND SWITCHING POWER SUPPLY

(71) Applicant: Silergy Semiconductor Technology (Hangzhou) LTD, Hangzhou (CN)

(72) Inventors: Shenhua Zhang, Hangzhou (CN); Sheng-Fu Hsiao, Kaohsiung City (TW); Chia-Chi Liu, Kaohsiung City (TW)

(21) Appl. No.: 18/985,337

(22) Filed: Dec. 18, 2024

(30) Foreign Application Priority Data
Dec. 28, 2023 (CN) 202311846079.5

(51) Int. Cl. H02M 3/158; H02M 1/32

(52) U.S. Cl. CPC H02M 3/158; H02M 1/32

(57) ABSTRACT

A control circuit for a switching power supply, can be configured to: obtain a switching frequency of a power transistor in the switching power supply in a sampling period; adjust an on-time of the power transistor to regulate a switching period of the power transistor to decrease a difference between the switching frequency and an expected switching frequency; and where the sampling period is greater than the switching period of the power transistor.

### RELATED APPLICATIONS

This application claims the benefit of Chinese Patent Application No. 202311846079.5, filed on Dec. 28, 2023, which is incorporated herein by reference in its entirety.

### FIELD OF THE INVENTION

The present invention generally relates to the field of power electronics technology, and more particularly to control circuits and associated switching power supplies.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of an example switching power supply with adaptive on-time control, in accordance with embodiments of the present invention.

FIG. 2 is a waveform diagram of the example switching power supply, in accordance with embodiments of the present invention.

FIG. 3 is a schematic block diagram of an example adaptive on-time circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Adaptive on-time (AOT) control is one of the most common control strategies for buck converters in fast dynamic applications. The on-time T_{ON} of the main power transistor in the buck converter changes adaptively with input voltage Vin and output voltage V_{OUT} in real time. As compared with constant on-time (COT) control, AOT control can achieve a relatively fixed switching frequency, which is more mainstream.

The turn-on-time of the main power transistor is typically determined by an ideal formula based on output voltage V_{OUT} and input voltage Vin. At no load or light load, the difference between the turn-on-time calculated by the ideal formula and the actual turn-on-time is relatively small. However, when the load gradually becomes heavy, the difference between the turn-on-time calculated by the ideal formula and the actual turn-on-time gradually increases. Therefore, the frequency for special operating conditions should be locked and corrected. The existing technology typically adopts a phase-locked loop (PLL) to correct the difference between the switching frequency obtained by sampling and the expected switching frequency, and on-time T_{ON} is adjusted by the AOT control.

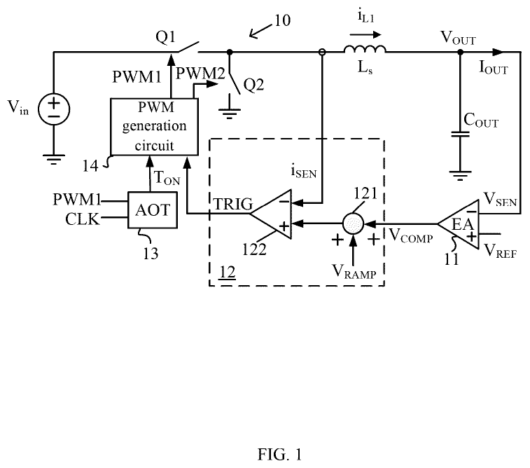

Referring now to FIG. 1, shown is a schematic block diagram of an example switching power supply with adaptive on-time control, in accordance with embodiments of the present invention. In this particular example, the power stage circuit of the switching power supply with adaptive on-time control is a buck circuit topography. However, any other suitable power stage circuit topographies can be supported in certain embodiments. In this particular example, power stage circuit 10 can include power transistors Q1 and Q2, and inductor Ls can connect between the common node of power transistors Q1 and Q2 and the output terminal of the switching power supply. Optionally, power stage circuit 10 can include output filter capacitor C_{OUT}. The power stage circuit may receive input voltage Vᵢₙ, and output the output voltage V_{OUT} after power conversion.

In particular embodiments, the control circuit may obtain the switching frequency of the power transistor in the switching power supply by sampling, and can compare the switching frequency against the expected switching frequency. When the switching frequency exceeds the upper limit of the expected switching frequency, the switching period of the power transistor may be increased. When the switching frequency is lower than the lower limit of the expected switching frequency, the switching period of the power transistor can be decreased, such that the switching frequency of the power transistor is constant. Further, because the switching frequency of power transistors Q1 and Q2 is the same, the switching frequency of either transistor can be sampled.

In particular embodiments, the control circuit can include error circuit 11, trigger signal generation circuit 12, adaptive on-time circuit 13, and pulse-width modulation (PWM) generation circuit 14. Error circuit 11 can amplify and compensate the error between voltage sampling signal V_{SEN} and reference voltage V_{REF} that characterizes the expected output voltage to generate voltage compensation signal V_{COMP}. Trigger signal generation circuit 12 can obtain trigger signal TRIG according to the comparison result of current sampling signal i_{SEN} and voltage compensation signal V_{COMP}, or according to the comparison result of current sampling signal i_{SEN} and the superposition signal of voltage compensation signal V_{COMP} and ramp signal V_{RAMP}.

In this particular example, trigger signal generation circuit 12 can include superposition circuit 121 and comparison circuit 122. Superposition circuit 121 can superimpose voltage compensation signal V_{COMP} and ramp signal V_{RAMP} to generate the superposition signal. The first input terminal of comparison circuit 122 may receive the superposition signal of voltage compensation signal V_{COMP} and ramp signal V_{RAMP}, and the second input terminal of comparison circuit 122 may receive current sampling signal i_{SEN}. Comparison circuit 122 can generate trigger signal TRIG at the output terminal.

Adaptive on-time circuit 13 can count the pulses of the switching control signal of the power transistor in sampling period T_{SAMP} to obtain switching frequency F_{SW}, and may adjust on-time T_{ON} of the main power transistor (e.g., power transistor Q1) according to the comparison result of switching frequency F_{SW} and expected switching frequency F_{REF}. Here, the range of expected switching frequency F_{REF} is F_{REF}−F_{LIM1}˜F_{REF}+F_{LIM2}, where limit values F_{LIM1} and F_{LIM2} can be the same or different. The limit values F_{LIM1} and F_{LIM2} can be a product of a smaller percentage and switching frequency F_{REF}, such as, e.g., 5% or 10%. Of course, the specific value is not limited here, and it can be determined according to particular circuit requirements.

PWM generation circuit 14 may receive on-time T_{ON} and trigger signal TRIG, and can generate switching control signals PWM1 and PWM2 for controlling power transistors Q1 and Q2. Trigger signal TRIG can set switching control signal PWM1 of power transistor Q1, and on-time T_{ON} can reset switching control signal PWM1 of power transistor Q1. In one control method, power transistors Q1 and Q2 are complementary. In another example, power transistors Q1 and Q2 may not be overlapped, and a dead time can be set between the on-times of the two power transistors.

As shown in FIG. 1, when the switching power supply works in continuous on-time mode, and considering the various parasitic parameters of the power stage circuit, the relationship between turn-on-time T_{ON} and switching frequency F_{SW}, output voltage V_{OUT}, input voltage Vᵢₙ, and other parameters in the circuit can be obtained as follows:

$${F}_{s w} = \frac{{V}_{OUT} + {I}_{O U T} \cdot ( DCR + {R}_{ON 2} )}{[ {V}_{i n} + {I}_{O U T} \cdot ( {R}_{ON 2} - {R}_{ON 1} ] \cdot {T}_{O N} + ( {V}_{F} + {I}_{OUT} {R}_{O N 2} ) \cdot {T}_{D}} \qquad ( 1 )$$

Here, DCR is the DC impedance of inductor Lₛ, R_{ON1} and R_{ON2} are the on-resistance of power transistors Q1 and Q2, respectively, T_{D} is the dead time, and V_{F} is the forward conduction voltage drop of the body diode of power transistor Q2. By introducing adaptive on-time circuit 13, a relatively simple relationship between on-time T_{ON} and switching frequency F_{SW}, output voltage V_{OUT} and input voltage Vᵢₙ is usually adopted, can be determined as shown in the following formula:

$${T}_{O N} = \frac{{V}_{OUT}}{{V}_{i n}} \cdot \frac{1}{{F}_{s w}} \qquad ( 2 )$$

Therefore, on-time T_{ON} can be configured to be positively correlated with the ratio of output voltage V_{OUT} to input voltage Vᵢₙ, and an approximately fixed switching frequency F_{SW} can be obtained. Also, output voltage V_{OUT} can be obtained by direct or indirect sampling, by sampling reference voltage V_{REF} representative of the expected output voltage, or can be obtained by indirect calculation of the duty cycle information of switching control signal PWM1 and input voltage Vᵢₙ, so long as output voltage V_{OUT} can be characterized. In addition, input voltage Vᵢₙ can also be sampled directly or indirectly.

Comparing Equations (1) and (2), it can be seen that the difference of on-time Ton calculated by Equations (1) and (2) is relatively small under no-load and light load, but the difference of on-time Ton calculated by Equations (1) and (2) increases gradually under heavy load. Therefore, the switching frequency for special operating conditions can be locked and corrected. As such, particular embodiments propose a new switching frequency correction scheme, whereby the control circuit fine-tunes on-time T_{ON} obtained by Equation (2), such that the final switching frequency F_{SW} falls within the range of the expected switching frequency and meets accuracy specification requirements of the switching frequency.

In particular embodiments, adaptive on-time circuit 13 can obtain switching frequency F_{SW} according to sampling clock signal CLK and switching control signal PWM1 that characterizes sampling period T_{SAMP}. Here, sampling period T_{SAMP} can be greater than the switching period of switching frequency F_{SW}. In one particular example, sampling period T_{SAMP} can be more than 100 times the switching period of switching frequency F_{SW}. It should be noted that any suitable specific multiple can be supported in certain embodiments, and may be determined according to the accuracy and response speed of the circuit.

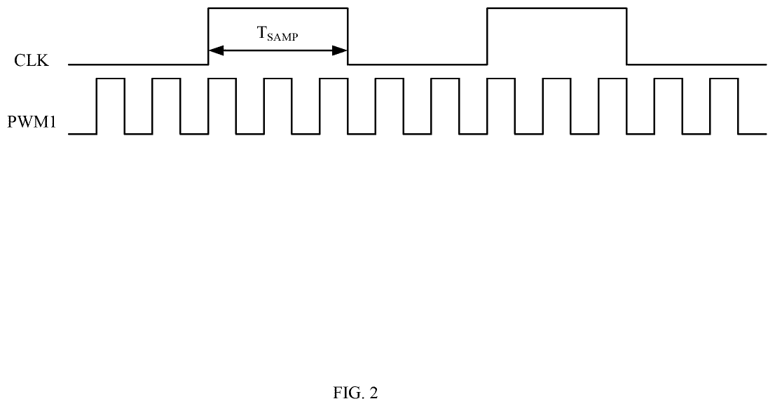

Referring now to FIG. 2, shown is a waveform diagram of the example switching power supply, in accordance with embodiments of the present invention. In this particular example, sampling period T_{SAMP} is the time during which sampling clock signal CLK continues to be a high-level pulse. In another example, sampling period T_{SAMP} can be the time during which sampling clock signal CLK continues to be a low-level pulse, and sampling period T_{SAMP} can also be synchronized with the period of sampling clock signal CLK.

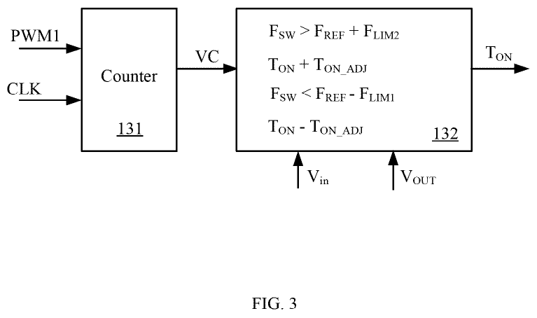

Referring now to FIG. 3, shown is a schematic block diagram of an example adaptive on-time circuit, in accordance with embodiments of the present invention. In this particular example, adaptive on-time circuit 13 can include counter 131 and on-time adjustment circuit 132. Counter 131 can obtain switching frequency F_{SW} according to sampling clock signal CLK and switching control signal PWM1 that characterizes sampling period T_{SAMP}, and compare the switching frequency F_{SW} against the expected switching frequency F_{REF} to obtain comparison result VC. For example, the range of expected switching frequency F_{REF} is F_{REF}−F_{LIM1}˜F_{REF}+F_{LIM1}. Comparison result VC can characterize the deviation between switching frequency F_{SW} and expected switching frequency F_{REF} to determine the adjustment trend of on-time T_{ON}.

Counter 131 can count the pulses of switching control signal PWM1 in sampling period T_{SAMP} to obtain switching frequency F_{SW}. Since sampling period T_{SAMP} is known, switching frequency F_{SW} can be calculated based on the count value of the pulse and sampling period T_{SAMP}. On-time adjustment circuit 132 can obtain on-time T_{ON} according to input voltage Vᵢₙ and output voltage V_{OUT} of the switching power supply, such that on-time T_{ON} has the same change trend with output voltage V_{OUT}, has the opposite change trend with input voltage Vᵢₙ, and on-time T_{ON} of power transistor Q1 is adjusted according to comparison result VC.

In particular embodiments, when adaptive on-time circuit 13 detects that switching frequency F_{SW} exceeds upper limit F_{REF}+F_{LIM1} of the expected switching frequency, on-time T_{ON} of power transistor Q1 can be increased by at least one step T_{ON_ADJ} in the next sampling period. That is, on-time T_{ON} of power transistor Q1 may be extended to not less than T_{ON}+T_{ON_ADJ}. For example, on-time T_{ON} of power transistor Q1 can be adjusted to T_{ON}+T_{ON_ADJ}, T_{ON}+2T_{ON_ADJ} or T_{ON}+3T_{ON_ADJ}, and so on.

When adaptive on-time circuit 13 detects that switching frequency F_{SW} is lower than lower limit F_{REF}−F_{LIM1} of the expected switching frequency, on-time T_{ON} Of power transistor Q1 can be decreased by at least one step T_{ON_ADJ} in the next sampling period. That is, on-time T_{ON} of the power transistor Q1 may not be greater than T_{ON}−T_{ON_ADJ}. For example, on-time T_{ON} of power transistor Q1 can be adjusted to T_{ON}−T_{ON_ADJ}, T_{ON}−2T_{ON_ADJ}, or T_{ON}−3T_{ON_ADJ}. For example, the duration of step T_{ON_ADJ} can be much smaller than on-time T_{ON} of power transistor Q1. It should be noted that sampling period T_{SAMP} may exceed the switching period of switching frequency F_{SW} by several orders of magnitude, and the duration of step T_{ON_ADJ} can be set to be much smaller than on-time T_{ON} of power transistor Q1, in order to avoid conflict with the original control loop caused by too fast frequency adjustment.

Particular embodiments may detect the switching frequency under steady-state operation within a longer sampling period, and then obtain the difference between the sampled switching frequency and the expected switching frequency, and without introducing any closed-loop control algorithm, and may directly increase or decrease the conduction of the main power tube according to the difference by the open-loop method, such that the switching frequency is close to constant. Particular embodiments may not require introduction of real-time PWM phase or frequency detection, which can greatly simplify the design complexity, and may not cause conflicts and oscillations to the original control loop.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A control circuit for a switching power supply, the control circuit being configured to:
a) obtain a switching frequency of a power transistor in the switching power supply in a sampling period;
b) adjust an on-time of the power transistor to regulate a switching period of the power transistor to decrease a difference between the switching frequency and an expected switching frequency; and
c) wherein the sampling period is greater than the switching period of the power transistor.

2. The control circuit of claim 1, wherein the on-time is adjusted independent of a control loop in at least one sampling period in accordance with a size relationship between the switching frequency and the expected switching frequency.

3. The control circuit of claim 2, wherein:
a) when the switching frequency is less than the expected switching frequency, the on-time is decreased by at least one step every other at least one sampling period; and
b) when the switching frequency is greater than the expected switching frequency, the on-time is increased by at least one step every other at least one sampling period.

4. The control circuit of claim 1, wherein:
a) when the switching frequency exceeds an upper limit of the expected switching frequency, the switching period of the power transistor is increased; and
b) when the switching frequency is lower than a lower limit of the expected switching frequency, the switching period of the power transistor is decreased, such that the switching period of the power transistor is within a range of the expected switching frequency.

5. The control circuit of claim 1, further comprising an adaptive on-time circuit configured to count pulses of a switching control signal for controlling the power transistor within the sampling period to obtain the switching frequency, and to adjust the on-time of the power transistor based on a comparison result between the switching frequency and the expected switching frequency.

6. The control circuit of claim 1, wherein a duration of the sampling period is at least 10 times a duration of the switching period.

7. The control circuit of claim 5, wherein the adaptive on-time circuit is configured to obtain the switching frequency according to a sampling clock signal characterizing the sampling period and the switching control signal, and wherein a duration during which the sampling clock signal lasts at a high level or at a low level is configured as one sampling period.

8. The control circuit of claim 3, wherein a time of one step is less than the on-time of the power transistor.

9. The control circuit of claim 5, further comprising a PWM generation circuit configured to receive the on-time and a trigger signal, and to generate the switching control signal of the power transistor accordingly, wherein the trigger signal is configured to set the switching control signal.

10. The control circuit of claim 5, wherein the adaptive on-time circuit comprises:
a) a counter configured to obtain the switching frequency according to a sampling clock signal characterizing the sampling period and the switching control signal, and compare the switching frequency against the expected switching frequency to obtain the comparison result; and
b) an on-time adjustment circuit configured to calculate the on-time according to an input voltage and an output voltage of the switching power supply, and to adjust the on-time of the power transistor according to the comparison result.

11. The control circuit of claim 10, wherein the on-time of the power transistor has a same changing trend as the output voltage, and an opposite changing trend as the input voltage.

12. A switching power supply, comprising the control circuit of claim 1, and further comprising a power stage circuit.

13. A method of controlling a switching power supply, the method comprising:
a) obtaining a switching frequency of a power transistor in the switching power supply in a sampling period;
b) adjusting an on-time of the power transistor to regulate a switching period of the power transistor to decrease a difference between the switching frequency and an expected switching frequency; and
c) wherein the sampling period is greater than the switching period of the power transistor.

14. The method of claim 13, wherein the on-time is adjusted independent of a control loop in at least one sampling period in accordance with a size relationship between the switching frequency and the expected switching frequency.

15. The method of claim 14, wherein:
a) when the switching frequency is less than the expected switching frequency, the on-time is decreased by at least one step every other at least one sampling period; and
b) when the switching frequency is greater than the expected switching frequency, the on-time is increased by at least one step every other at least one sampling period.

16. The method of claim 13, wherein:
a) when the switching frequency exceeds an upper limit of the expected switching frequency, the switching period of the power transistor is increased; and
b) when the switching frequency is lower than a lower limit of the expected switching frequency, the switching period of the power transistor is decreased, such that the switching period of the power transistor is within a range of the expected switching frequency.

17. The method of claim 13, further comprising:
a) counting pulses of a switching control signal for controlling the power transistor within the sampling period to obtain the switching frequency; and
b) adjusting the on-time of the power transistor based on a comparison result between the switching frequency and the expected switching frequency.

18. The method of claim 13, wherein a duration of the sampling period is at least 10 times a duration of the switching period.

19. The method of claim 17, wherein the switching frequency is obtained according to a sampling clock signal characterizing the sampling period and the switching control signal, and wherein a duration during which the sampling clock signal lasts at a high level or at a low level is configured as one sampling period.

20. The method of claim 15, wherein a time of one step is less than the on-time of the power transistor.
